(19) United States
(12) Patent Application Publication
(10) Pub. No.: US 2026/0134550 A1
(43) Pub. Date: May 14, 2026

(54) OPTIMIZING SPATIO-TEMPORAL REASONING IN VISION-LANGUAGE MODELS

(71) Applicant: NEC Laboratories America, Inc., Princeton, NJ (US)

(72) Inventors: Yumin Suh, Santa Clara, CA (US); Vijay Kumar Baikampady Gopalkrishna, San Jose, CA (US); Dohwan Ko, San Jose, CA (US)

(21) Appl. No.: 19/377,508

(22) Filed: Nov. 3, 2025

Related U.S. Application Data
(60) Provisional application No. 63/719,694, filed on Nov. 13, 2024.

(51) Int. Cl. G06T 7/20; B60W 60/00

(52) U.S. Cl. CPC G06T 7/20; B60W 60/0027; B60W 2420/408; B60W 2554/4044; G06T 2207/10016; G06T 2207/10028; G06T 2207/20081; G06T 2207/20084; G06T 2207/30241

(57) ABSTRACT

Systems and methods for optimizing spatio-temporal reasoning in artificial intelligence models. Fine-tuning tasks including instruction-following data using coordinates can be generated from LiDAR annotations in real world dynamic videos. A visual-language machine learning model (VLM) can be fine-tuned with the fine-tuning tasks that increases spatio-temporal reasoning of the VLM. Biased verification can be prevented by verifying the spatio-temporal reasoning of the VLM based on a prediction generated by the VLM in natural language for ensuring increased accuracy of the VLM.

### RELATED APPLICATION INFORMATION

This application claims priority to U.S. Provisional App. No. 63/719,694, filed on Nov. 13, 2024, incorporated herein by reference in its entirety.

### BACKGROUND

### Technical Field

The present invention relates to optimizing artificial intelligence (AI) models, and more particularly to optimizing spatio-temporal reasoning in vision-language models.

### Description of the Related Art

AI models have been created and used to replicate human function such as logical reasoning, visual identification, and prediction. The accuracy of these AI models are linked to how they are trained, the quality of training data, and the methods used for training. As such, the better the quality of training data and training method, the better accuracy that the AI model would have.

### SUMMARY

According to an aspect of the present invention, a method is provided including generating fine-tuning tasks including instruction-following data using coordinates from LiDAR annotations in real world dynamic videos, fine-tuning a visual-language machine learning model (VLM) with the fine-tuning tasks that increases spatio-temporal reasoning of the VLM, and preventing biased verification by verifying the spatio-temporal reasoning of the VLM based on a prediction generated by the VLM in natural language for ensuring increased accuracy of the VLM.

According to another aspect of the present invention, a system is provided including, a memory device, one or more processor devices operatively coupled with the memory device to perform operations including, generating fine-tuning tasks including instruction-following data using coordinates from LiDAR annotations in real world dynamic videos, fine-tuning a visual-language machine learning model (VLM) with the fine-tuning tasks that increases spatio-temporal reasoning of the VLM, and preventing biased verification by verifying the spatio-temporal reasoning of the VLM based on a prediction generated by the VLM in natural language for ensuring increased accuracy of the VLM.

According to yet another aspect of the present invention, a non-transitory computer program product is provided comprising a computer-readable storage medium including a program code, wherein the program code when executed on a computer causes the computer to perform operations including, generating fine-tuning tasks including instruction-following data using coordinates from LiDAR annotations in real world dynamic videos, fine-tuning a visual-language machine learning model (VLM) with the fine-tuning tasks that increases spatio-temporal reasoning of the VLM, and preventing biased verification by verifying the spatio-temporal reasoning of the VLM based on a prediction generated by the VLM in natural language for ensuring increased accuracy of the VLM.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram that shows a system for optimizing spatio-temporal reasoning in artificial intelligence models is illustratively depicted in accordance with one embodiment of the present invention;

FIG. 2 is a block diagram that shows a computer system for optimizing spatio-temporal reasoning in artificial intelligence models, in accordance with an embodiment of the present invention;

FIG. 3 is a block diagram that shows hardware and software components of a computer system for optimizing spatio-temporal reasoning in artificial intelligence models, in accordance with an embodiment of the present invention;

FIG. 4 is a block diagram that shows a neural network for optimizing spatio-temporal reasoning in artificial intelligence models, in accordance with an embodiment of the present invention; and

FIG. 5 is a flow diagram that shows a high-level overview of a method for optimizing spatio-temporal reasoning in artificial intelligence models, in accordance with an embodiment of the present invention.

### DETAILED DESCRIPTION OF PREFERRED EMBODIMENTS

In accordance with embodiments of the present invention, systems and methods are provided for optimizing spatio-temporal reasoning in artificial intelligence models.

In the present embodiments, fine-tuning tasks including instruction-following data using coordinates can be generated from light detection and ranging (LiDAR) annotations in real world dynamic videos. A visual-language machine learning model (VLM) can be fine-tuned with the fine-tuning tasks that increases spatio-temporal reasoning of the VLM. Biased verification can be prevented by verifying the spatio-temporal reasoning of the VLM based on a prediction generated by the VLM in natural language for ensuring increased accuracy of the VLM.

Spatio-temporal reasoning is the ability to infer spatial and temporal relationships within dynamic environments. For example, when analyzing a video of two cars driving on a road, spatio-temporal reasoning enables us to predict which car is moving faster or to accurately estimate the movement direction and speed of a specific vehicle. This high-level reasoning capability is essential in various applications, including autonomous driving, augmented and virtual reality, and sports analytics. In fact, even humans often find it challenging to perform advanced spatio-temporal reasoning; for instance, estimating the exact distance a car has traveled on a real-world scale from a short video is difficult without specialized expertise.

Recent studies have attempted to enhance the spatial reasoning capabilities of Vision-Language Models (VLMs) in a single image through the use of large-scale data curation pipelines. These efforts involve annotating extensive images with 3D spatial information, such as object depth and size. While these approaches have shown improvements in spatial reasoning, they fall short of being extended to spatio-temporal reasoning in the video domain. Specifically, VLMs trained solely on spatial reasoning datasets perform poorly on tasks that require temporal understanding because they are limited to analyzing static spatial relationships in still images and cannot process temporal dynamics like motion and kinematics. To enable effective spatio-temporal reasoning, it is necessary to develop datasets comprising videos, especially dynamic videos featuring significant object movements and to annotate them with 4D spatio-temporal information such as traveled distance and direction.

Building on these limitations, the present embodiments presents an approach that extends beyond spatial reasoning in the image domain to address spatio-temporal challenges in the video domain for video VLMs. The present embodiments can generate the instruction-following dataset based on LiDAR annotations from videos, specifically focusing on dynamic scenes where significant object movement occurs. By leveraging precise 3D coordinates obtained at each timestamp, detailed question-answer (QA) pairs can be created for the instruction-following data that encompass various spatio-temporal reasoning tasks involving motion and kinematics. By training VLMs on both high-quality LiDAR-based data and pseudo-labeled data, the present embodiments can understand both spatial information and temporal dynamics. Thus, the present embodiments demonstrate superior performance over baselines on various spatio-temporal benchmarks.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

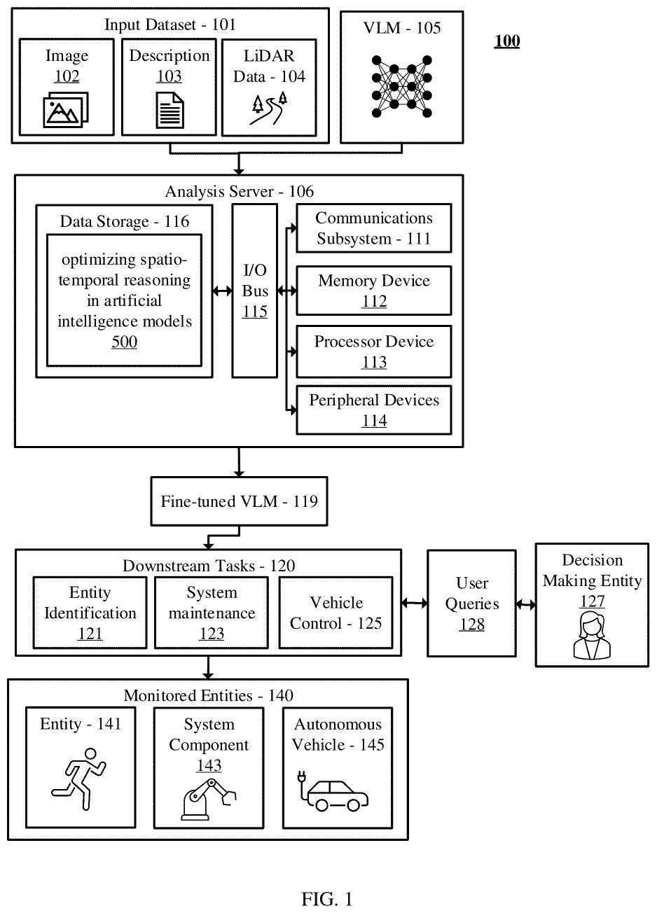

Referring now in detail to the figures in which like numerals represent the same or similar elements and initially to FIG. 1, a block diagram that shows a system for optimizing spatio-temporal reasoning in artificial intelligence models is illustratively depicted in accordance with one embodiment of the present invention.

In an embodiment using a system 100, monitored entities 140 can include entity 141, system component 143, and autonomous vehicle 145. The monitored entities 140 can generate an input dataset 101. The input dataset 101 can include image 102, text description 103, and light detection and ranging (LiDAR) data 104. The input dataset 101 can be transmitted to an analytic server 106 that can implement optimizing spatio-temporal reasoning in artificial intelligence models 500. The analytic server 106 can communicate with a multi-modal large language model (such as a visual language machine learning model (VLM) 105).

System 300 can be utilized to perform downstream tasks 120 based on the input dataset 101 and user queries 128 from a decision-making entity 127. The downstream tasks 120 can include entity identification 121, system maintenance 123, and vehicle control 125. The analytic server 106 can generate a corrective action for the downstream tasks 120 to be sent to respective computing systems for the monitored entities 140 through a network.

In entity identification 121, the input dataset 101 (e.g., location images, scene images, entity images such as parts of the entity, etc.) related to the entity 141 can be processed by the analysis server 106 to answer user queries 128. The user queries 128 can be relevant to the entity 141 such as their attributes (e.g., position, direction of movement, color of clothing, etc.), relationship with other entities within a scene (e.g., proximity, behavior, etc.), relationship with the environment, etc. The fine-tuned VLM 107 can predict future attributes, and relationships of the entity 141.

Based on the predictions of the fine-tuned VLM 107, a corrective action can be generated by the fine-tuned VLM 107. The corrective action can include notifying the decision making entity 127 of the predictions about the entity 141 based on their input dataset 101, generating resolutions to an issue caused by the entity (e.g., the entity 141 as a disabled vehicle in a traffic scene and the resolution is the deployment of a repair technician, etc.) of the input dataset 101 to help with the decision making process of the decision making entity 127, etc.

In system maintenance 123, input dataset 101 (e.g., system logs, test cases, hardware status images, etc.) related to the system component 143 can be processed to answer user queries 128. The user queries 128 can be relevant on how to properly maintain the system component 143 based on the input dataset 101. A corrective action can be generated by the analytic server 106 which can include the answer to the user queries 128 (e.g., determine causes to bandwidth issues, etc.) to maintain the system component 143. Based on the corrective action (e.g., adding bandwidth, blocking packets from an identified internet protocol (IP) address to resolve malicious attacks, restarting hardware, etc.) the network system can be autonomously maintained.

In vehicle control 125, input dataset 101 (e.g., vehicle part status, traffic scene image, etc.) related to the autonomous vehicle 145 can be processed to answer user queries 128. The user queries 128 can be relevant to how to control the autonomous vehicle 145 given its environment based on the input dataset 101. A corrective action can be generated by the analytic server 106 which can include the answer to the user queries 128 to control the proper performance of the autonomous vehicle 145. Based on the corrective action (e.g., stopping, speeding up, changing direction, etc.) the autonomous vehicle 145 can be autonomously controlled using appropriate control devices (e.g., advanced driver assistance systems, braking device, accelerator device, cooling device, etc.) within the autonomous vehicle. In an embodiment, the autonomous vehicle 145 can be controlled in response to a predicted event based on a generated trajectory such as multi-vehicle collision, accidents, road hazards, etc.

In another embodiment, in vehicle control 125, the autonomous vehicle 145 can be controlled to verify and test the functionality of the various components (e.g., advanced driver assistance systems, braking device, accelerator device, cooling device, etc.) of the autonomous vehicle 145 by autonomously controlling the components and generate test data that can be used to fine-tune the fine-tuned VLM 107.

Other downstream tasks and practical applications are contemplated.

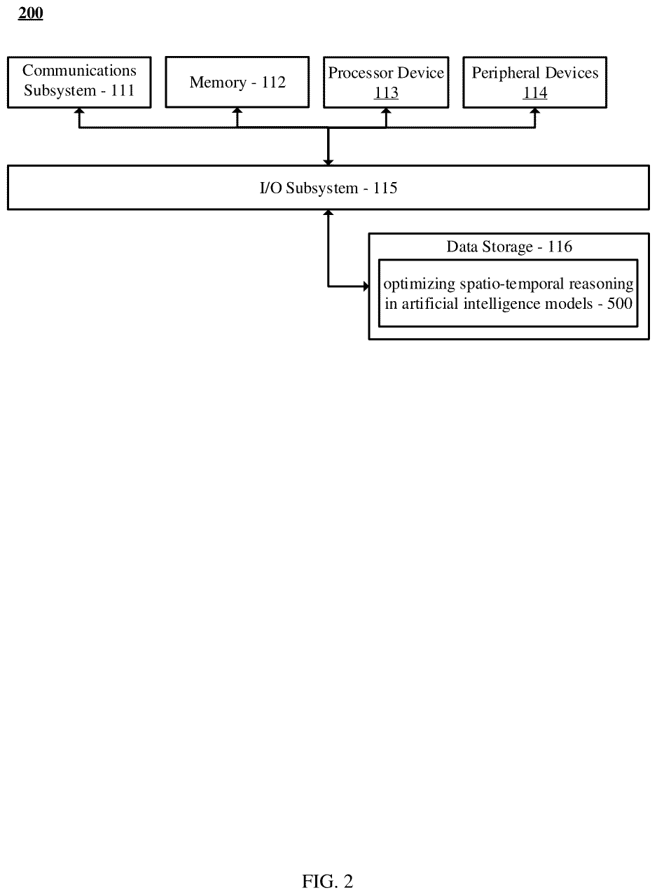

The analytic server 106 can include a processor device 113, data storage device 116, memory 112, communications subsystem 111, peripheral devices 114, and input/output (I/O) bus 115. The analytic server 106 is an implementation of a computer system. Other implementations are contemplated. The computer system is shown in more detail in FIG. 2.

Referring now to FIG. 2, a block diagram that shows a computer system for optimizing spatio-temporal reasoning in artificial intelligence models, in accordance with an embodiment of the present invention.

The computing device 200 illustratively includes the processor device 113, an input/output (I/O) subsystem 190, a memory 112, a data storage device 116, and a communications subsystem 111, and/or other components and devices commonly found in a server or similar computing device. The computing device 200 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 112, or portions thereof, may be incorporated in the processor device 113 in some embodiments.

The processor device 113 may be embodied as any type of processor capable of performing the functions described herein. The processor device 113 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 112 may be embodied as any type of volatile or non-volatile memory or data storage capable of performing the functions described herein. In operation, the memory 112 may store various data and software employed during operation of the computing device 200, such as operating systems, applications, programs, libraries, and drivers. The memory 112 is communicatively coupled to the processor device 113 via the I/O subsystem 115, which may be embodied as circuitry and/or components to facilitate input/output operations with the processor device 113, the memory 112, and other components of the computing device 200. For example, the I/O subsystem 115 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 115 may form a portion of a system-on-a-chip (SOC) and be incorporated, along with the processor device 113, the memory 112, and other components of the computing device 200, on a single integrated circuit chip.

The data storage device 116 may be embodied as any type of device or devices configured for short-term or long-term storage of data such as, for example, memory devices and circuits, memory cards, hard disk drives, solid state drives, or other data storage devices. The data storage device 116 can store program code for optimizing spatio-temporal reasoning in artificial intelligence models 500. Any or all of these program code blocks may be included in a given computing system.

The communications subsystem 111 of the computing device 200 may be embodied as any network interface controller or other communication circuit, device, or collection thereof, capable of enabling communications between the computing device 200 and other remote devices over a network. The communications subsystem 111 may be configured to employ any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 200 may also include one or more peripheral devices 114. The peripheral devices 114 may include any number of additional input/output devices, interface devices, and/or other peripheral devices. For example, in some embodiments, the peripheral devices 114 may include a display, touch screen, graphics circuitry, keyboard, mouse, speaker system, microphone, network interface, and/or other input/output devices, interface devices, GPS, camera, and/or other peripheral devices.

Of course, the computing device 200 may also include other elements (not shown), as readily contemplated by one of skill in the art, as well as omit certain elements. For example, various other sensors, input devices, and/or output devices can be included in computing device 200, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing device 200 are readily contemplated by one of ordinary skill in the art given the teachings of the present invention provided herein.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

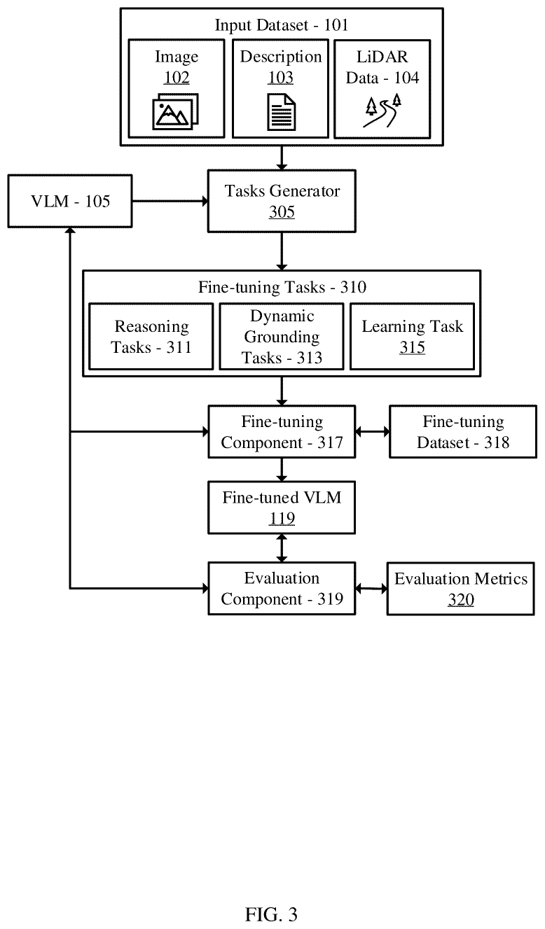

Referring now to FIG. 3, a block diagram that shows hardware and software components of a computer system for optimizing spatio-temporal reasoning in artificial intelligence models, in accordance with an embodiment of the present invention.

In an embodiment, input dataset 101 can be processed by a tasks generator 305 to generate fine-tuning tasks 310 which can be processed by a fine-tuning component 317 to obtain a fine-tuned VLM 107. The evaluation component 319 can ensure that accuracy of the fine-tuned VLM 107 with the evaluation metrics 320. The input dataset 101 can include image 102, description 103, and light detection and ranging (LiDAR) data 104. The VLM 105 can be pre-trained for spatio-temporal reasoning such as image processing, scene understanding, question-answering, etc. The VLM 105 can be trained for 1 epoch with a batch size of 16. The cosine learning rate scheduler can be adapted with a predefined learning rate (e.g., 1e-5).

The task generator 305 can utilize the VLM 105 to generate the fine-tuning tasks 310. The fine-tuning tasks 310 can include reasoning tasks 311, dynamic grounding tasks 313, and learning task 315. The reasoning tasks 311 can include tasks that enable the VLM 105 to increase its reasoning capabilities (e.g., question answering, explainability, etc.). The dynamic grounding tasks 313 can include tasks that enable the VLM 105 to increase its ability to accurately estimate physical attributes (e.g., position, speed, orientation, pose, etc.) of an entity in a scene. The learning tasks 315 can include task that enable the VLM 105 to increase its learning capabilities.

The fine-tuning component 317 can utilize the fine-tuning tasks 310 to fine-tune the VLM 105 and obtain a fine-tuned VLM 119 having optimized spatio-temporal reasoning. The VLM 105 and the fine-tuned VLM 119, can utilize neural networks.

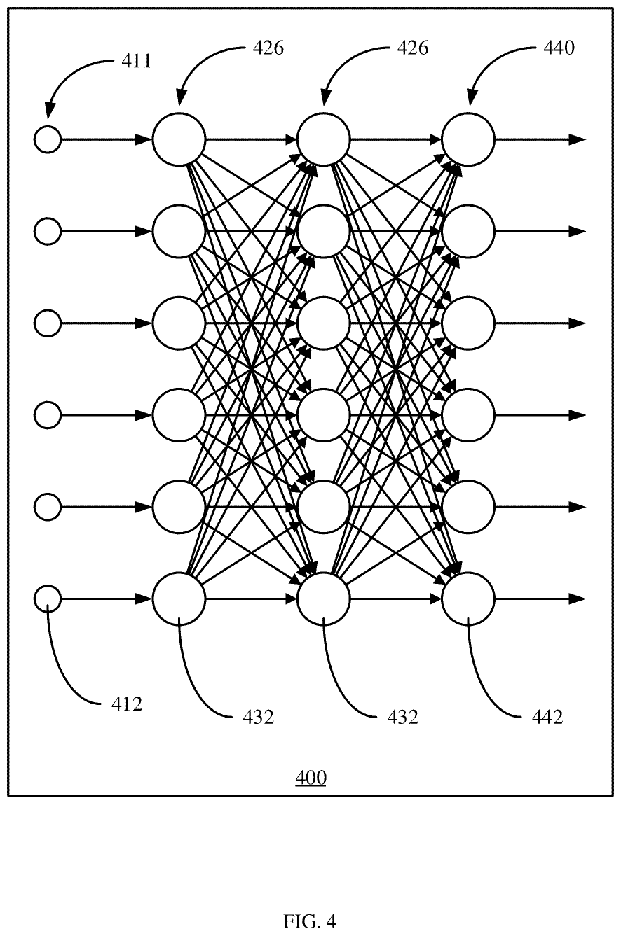

Referring now to FIG. 4, a block diagram that shows a neural network for optimizing spatio-temporal reasoning in artificial intelligence models, in accordance with an embodiment of the present invention.

A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types and may include multiple distinct values. The network can have one input neurons for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

The deep neural network 400, such as a multilayer perceptron, can have an input layer 411 of source neurons 412, one or more computation layer(s) 426 having one or more computation neurons 432, and an output layer 440, where there is a single output neuron 442 for each possible category into which the input example could be classified. An input layer 411 can have a number of source neurons 412 equal to the number of data values 412 in the input data 411. The computation neurons 432 in the computation layer(s) 426 can also be referred to as hidden layers, because they are between the source neurons 412 and output neuron(s) 442 and are not directly observed. Each neuron 432, 442 in a computation layer generates a linear combination of weighted values from the values output from the neurons in a previous layer, and applies a non-linear activation function that is differentiable over the range of the linear combination. The weights applied to the value from each previous neuron can be denoted, for example, by w₁, w₂, . . . wₙ₋₁, wₙ. The output layer provides the overall response of the network to the inputted data. A deep neural network can be fully connected, where each neuron in a computational layer is connected to all other neurons in the previous layer, or may have other configurations of connections between layers. If links between neurons are missing, the network is referred to as partially connected.

Training a deep neural network can involve two phases, a forward phase where the weights of each neuron are fixed and the input propagates through the network, and a backwards phase where an error value is propagated backwards through the network and weight values are updated. The computation neurons 432 in the one or more computation (hidden) layer(s) 426 perform a nonlinear transformation on the input data 412 that generates a feature space. The classes or categories may be more easily separated in the feature space than in the original data space. In an embodiment, the neural network 400 of the VLM 105 can be trained with the input data 101 to perform spatio-temporal reasoning which can be optimized by utilizing the fine-tuning tasks 310. In an embodiment, the optimized spatio-temporal reasoning of the VLM 105 can be verified using the evaluation metrics 320.

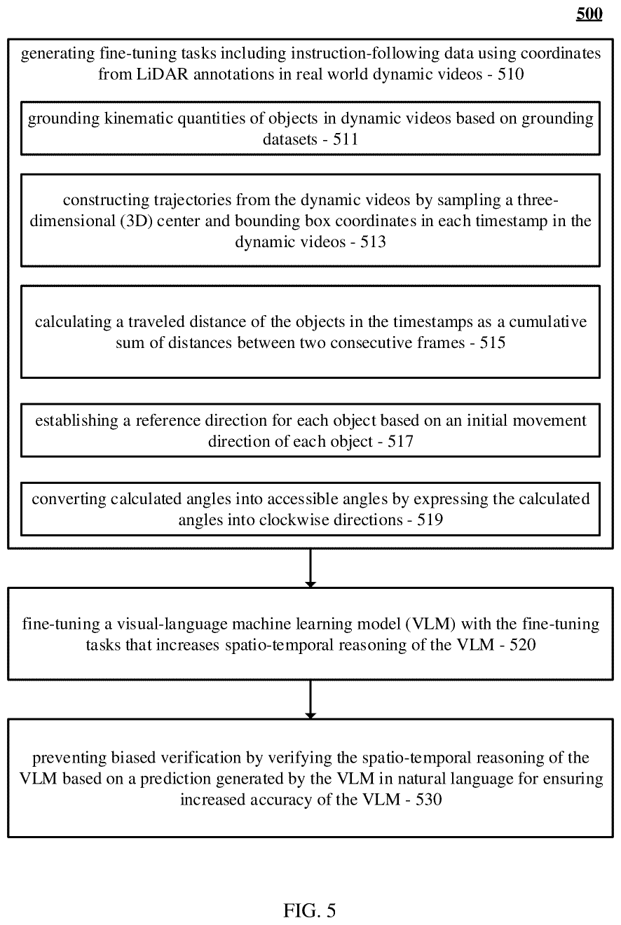

Referring now to FIG. 5, a flow diagram that shows a high-level overview of a method for optimizing spatio-temporal reasoning in artificial intelligence models, in accordance with an embodiment of the present invention.

In an embodiment, fine-tuning tasks including instruction-following data using coordinates can be generated from LiDAR annotations in real world dynamic videos. A visual-language machine learning model (VLM) can be fine-tuned with the fine-tuning tasks that increases spatio-temporal reasoning of the VLM. Biased verification can be prevented by verifying the spatio-temporal reasoning of the VLM based on a prediction generated by the VLM in natural language for ensuring increased accuracy of the VLM.

In block 510, fine-tuning tasks including instruction-following data can be generated using coordinates from LiDAR annotations in real world dynamic videos.

In an embodiment, the fine-tuning tasks 310 can include instruction-following data that can enhance the spatio-temporal reasoning capabilities of VLMs from various perspectives. The fine-tuning tasks 310 can be grouped into single object and multiple object tasks. Each grouping of the fine-tuning tasks can be sub-grouped into distance and direction.

The fine-tuning tasks 310 can encourage the model to understand both the absolute distance and direction of an object's movement, as well as the relative distance and direction by comparing multiple objects. To successfully manage these tasks, the model can infer spatial information (e.g., object localization) and temporal information (e.g., object tracking), enabling the development of complex spatio-temporal reasoning abilities that build upon the prior knowledge of Large Language Models (LLMs).

The fine-tuning tasks 310 can include the spatio-temporal grounding of dynamic videos.

In block 511, kinematic quantities of objects in dynamic videos can be grounded based on grounding datasets.

In an embodiment, to generate instruction-following data for the spatio-temporal reasoning tasks, grounding the kinematic quantities of objects in dynamic videos can be performed. The kinematic quantities can include their trajectories, traveled distance and movement directions. Videos with substantial object movement are most suitable for these tasks. Thus, grounding datasets such as autonomous driving datasets (e.g., NuScenes and Argoverse2) which contain dynamic outdoor scenes can be utilized. The grounding datasets can provide high-quality 3D object coordinates at each timestamp, represented in real-world scales as world coordinates, captured using LiDAR sensors.

In block 513, trajectories from the dynamic videos can be constructed by sampling a three-dimensional (3D) center and bounding box coordinates in each timestamp in the dynamic videos.

In an embodiment, the 3D center and 3D bounding box coordinates in the world space can be accessed for every object in the video from the ground dataset for each timestamp to construct the trajectories of each object. By utilizing the 3D center coordinate

$${P}_{t}^{( i )}$$

of 1-th object at t seconds, the trajectories can be constructed by sampling the center at a predetermined interval (e.g., 0.5-second intervals) over a number of frames (e.g., 40-frames) videos to cover a length of videos (e.g., 20 seconds of video).

In block 515, a traveled distance of the objects in the timestamps can be calculated as the cumulative sum of distances between two consecutive frames.

In an embodiment, to calculate the traveled distance of the objects, the following can be computed:

$${\sum }_{t = s}^{e - 1} {‖ {P}_{t}^{( i )} - {P}_{t + 1}^{( i )} ‖}_{2}^{2} .$$

The traveling speed can also be calculated by dividing the total traveled distance by the duration e−s.

In block 517, a reference direction for each object can be established based on an initial movement direction of each object.

In an embodiment, to establish the reference direction for each object, the initial movement direction can be calculated from the first two frames in which it appears. This can be computed as:

$${P}_{s + 1}^{( i )} - {P}_{s}^{( i )} .$$

Subsequent movement directions can be computed as relative angles to this reference vector as:

$${θ}_{t} = arc cos ( \frac{( {P}_{t + 1}^{( i )} - {P}_{t}^{( i )} ) \cdot ( {P}_{s + 1}^{( i )} - {P}_{s}^{( i )} )}{‖ {P}_{t + 1}^{( i )} - {P}_{t}^{( i )} ‖ ‖ {P}_{s + 1}^{( i )} - {P}_{s}^{( i )} ‖} ) .$$

In block 519, calculated angles can be converted into accessible angles by expressing the calculated angles into clockwise directions.

Describing direction with angles is not intuitive to humans, as humans do not typically use exact degrees. In an embodiment, to make angular description of directions more accessible for both humans and VLMs, calculated angles can be converted into accessible angles by converting the calculated angles into clockwise directions. The initial reference direction can be set as 12 o'clock, with subsequent directions expressed relative to this reference.

In block 520, the VLM can be fine-tuned with the fine-tuning tasks to increase spatio-temporal reasoning of the VLM.

In an embodiment, the VLM 105 can be fine-tuned to increase its spatio-temporal reasoning using the fine-tuning tasks 310. The VLM 105 can be LLaVA-One Vision, which can deal with various forms of visual inputs, e.g., single image, multi-images, and video, with both generated 4D reconstruction-based pseudo-labeled and LiDAR-based high-quality spatio-temporal reasoning data and develop LLaVA-ST. However, fine-tuning only with spatio-temporal reasoning data degrades the performance on other generic benchmarks, implying that the model becomes overfitted to this task.

To resolve this issue, in an embodiment, the spatio-temporal reasoning dataset can be combined with a subset of general supervised finetuning (SFT) datasets, such as, LLaVA-Video-178K. By blending these datasets, emergent abilities, including complex reasoning skills that were not present in predefined templates, can be empirically observed. Furthermore, an additional SFT dataset, such as OpenSpatialDataset, can be utilized to enhance the model's spatial reasoning ability which is potentially advantageous in spatio-temporal reasoning.

With the distance and direction information, a template-based approach can be adopted to construct QA pairs for the instruction-following dataset. For example, an instruction-following data for a fine-tuning task 310 for a single object, with a distance subcategory, that processes traveled distance can include predicting a total traveled distance of the object given a timestamp. The template for this fine-tuning task 310 can include “can you calculate the total distance the object traveled between [START] and [END] seconds?”

Furthermore, to provide an object location to the model, a bounding box can be overlaid on each frame. Then, the generated QA pair and the video with bounding boxes are fed into the model for training and inference. The model can be trained using a next-token prediction loss function. During training, the model receives as input both the textual question and a video in which bounding boxes are overlaid on relevant regions. The model is optimized to generate the corresponding textual answer as output.

In block 530, biased verification can be prevented by verifying the spatio-temporal reasoning of the VLM based on a prediction extracted from a response of a large language model in natural language for ensuring increased accuracy of the VLM.

There is no benchmark for assessing spatio-temporal reasoning ability of the VLM 105, e.g., traveled distance, traveling speed, and moving direction.

In an embodiment, to verify the spatio-temporal reasoning ability of the VLM 105 evaluation metrics 320 that can include a Spatio-Temporal Reasoning Benchmark (STRBench) can be constructed. To utilize STRBench, the validation set of annotated datasets (e.g., NuScenes™ and Argoverse2™), which contain high-quality LiDAR sensor-based annotations, for QA pairs in STRBench. Each task in STRBench can include 200 QA pairs, resulting in a total of 1,400 QA pairs. However, directly adopting generated QA pairs for the benchmark exhibits long-tail label distribution. Therefore, to prevent biased evaluation results in STRBench, the number of samples for each label can be balanced based on a predetermined ratio of question-answer pairs for the tasks. For evaluation, a generative AI model (e.g., GPT-4™) can be used to extract the prediction from the response in natural language.

In block 531, the prediction of the fine-tuned VLM and the ground truth can be compared based on evaluation metrics.

In an embodiment, given the ground-truth answer y and the prediction y, the evaluation metrics 320 can include the following:

For fine-tuning tasks that processes traveled distance and traveling speed: Accuracy (correct if y×0.75≤ŷ≤y×1.25) and mean absolute error (MAE) (|y−ŷ|).

For fine-tuning tasks that processes moving direction: Accuracy (correct if y=ŷ in the clockwise direction) and MAE (|y−ŷ| in the clockwise direction).

For fine-tuning tasks that processes direction timestamp: Accuracy (correct if IoU(y, ŷ)≥0.5) and intersection over union (IoU).

For fine-tuning tasks that processes traveled distance comparison, traveling speed comparison, and moving direction comparison: Accuracy (binary classification).

In another embodiment, the VLM 105 can learn additional evaluation metrics based on historical data and past evaluation metrics.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method, comprising:
generating fine-tuning tasks including instruction-following data using coordinates from light detection and ranging (LiDAR) annotations in real world dynamic videos;
fine-tuning a visual-language machine learning model (VLM) with the fine-tuning tasks that increases spatio-temporal reasoning of the VLM; and
preventing biased verification by verifying the spatio-temporal reasoning of the VLM based on a prediction generated by the VLM in natural language for ensuring increased accuracy of the VLM.

2. The method of claim 1, wherein generating the fine-tuning tasks further comprises grounding kinematic quantities of objects in dynamic videos based on grounding datasets.

3. The method of claim 2, wherein generating the fine-tuning tasks further comprises constructing trajectories from the dynamic videos by sampling a three-dimensional (3D) center and bounding box coordinates in each timestamp in the dynamic videos.

4. The method of claim 3, wherein generating the fine-tuning tasks further comprises calculating a traveled distance of the objects in the timestamps as a cumulative sum of distances between two consecutive frames.

5. The method of claim 2, wherein generating the fine-tuning tasks further comprises establishing a reference direction for each object based on an initial movement direction of each object.

6. The method of claim 1, wherein generating the fine-tuning tasks further comprises converting calculated angles into accessible angles by expressing the calculated angles into clockwise directions.

7. The method of claim 1, further comprising controlling an autonomous vehicle with a trajectory generated by the fine-tuned VLM that avoids a predicted collision.

8. A system, comprising:
a memory device;
one or more processor devices operatively coupled with the memory device to perform operations including:
generating fine-tuning tasks including instruction-following data using coordinates from light detection and ranging (LiDAR) annotations in real world dynamic videos;
fine-tuning a visual-language machine learning model (VLM) with the fine-tuning tasks that increases spatio-temporal reasoning of the VLM; and
preventing biased verification by verifying the spatio-temporal reasoning of the VLM based on a prediction generated by the VLM in natural language for ensuring increased accuracy of the VLM.

9. The system of claim 8, wherein generating the fine-tuning tasks further comprises grounding kinematic quantities of objects in dynamic videos based on grounding datasets.

10. The system of claim 9, wherein generating the fine-tuning tasks further comprises constructing trajectories from the dynamic videos by sampling a three-dimensional (3D) center and bounding box coordinates in each timestamp in the dynamic videos.

11. The system of claim 10, wherein generating the fine-tuning tasks further comprises calculating a traveled distance of the objects in the timestamps as a cumulative sum of distances between two consecutive frames.

12. The system of claim 9, wherein generating the fine-tuning tasks further comprises establishing a reference direction for each object based on an initial movement direction of each object.

13. The system of claim 8, wherein generating the fine-tuning tasks further comprises converting calculated angles into accessible angles by expressing the calculated angles into clockwise directions.

14. The system of claim 8, further comprising controlling an autonomous vehicle with a trajectory generated by the fine-tuned VLM that avoids a predicted collision.

15. A non-transitory computer program product comprising a computer-readable storage medium including a program code, wherein the program code when executed on a computer causes the computer to perform operations including:
generating fine-tuning tasks including instruction-following data using coordinates from light detection and ranging (LiDAR) annotations in real world dynamic videos;
fine-tuning a visual-language machine learning model (VLM) with the fine-tuning tasks that increases spatio-temporal reasoning of the VLM; and
preventing biased verification by verifying the spatio-temporal reasoning of the VLM based on a prediction generated by the VLM in natural language for ensuring increased accuracy of the VLM.

16. The non-transitory computer program product of claim 15, wherein generating the fine-tuning tasks further comprises grounding kinematic quantities of objects in dynamic videos based on grounding datasets.

17. The non-transitory computer program product of claim 16, wherein generating the fine-tuning tasks further comprises constructing trajectories from the dynamic videos by sampling a three-dimensional (3D) center and bounding box coordinates in each timestamp in the dynamic videos.

18. The non-transitory computer program product of claim 17, wherein generating the fine-tuning tasks further comprises calculating a traveled distance of the objects in the timestamps as a cumulative sum of distances between two consecutive frames.

19. The non-transitory computer program product of claim 16, wherein generating the fine-tuning tasks further comprises establishing a reference direction for each object based on an initial movement direction of each object.

20. The non-transitory computer program product of claim 15, further comprising controlling an autonomous vehicle with a trajectory generated by the fine-tuned VLM that avoids a predicted collision.
